(19) United States
(12) Patent Application Publication
(10) Pub. No.: US 2017/0012366 A1
(43) Pub. Date: Jan. 12, 2017

(54) CONNECTOR, MACHINE ELEMENT AND METHOD FOR MAKING CONTACT WITH CONTACT PADS ON A MACHINE ELEMENT

(71) Applicant: SCHAEFFLER TECHNOLOGIES AG & CO. KG, Herzogenaurach (DE)

(72) Inventor: Jens Heim, Bergrheinfeld (DE)

(73) Assignee: Schaeffler Technologies AG & Co. KG, Herzogenaurach (DE)

(21) Appl. No.: 15/116,333

(22) PCT Filed: Dec. 8, 2014
(86) PCT No.: PCT/DE2014/200684

§ 371 Date: Aug. 3, 2016

(30) Foreign Application Priority Data
Feb. 4, 2014 (DE) 10 2014 201 912.5

(51) Int. Cl. H01R 4/38; H01R 13/24; H01R 4/48

(52) U.S. Cl. CPC H01R 4/38; H01R 4/48; H01R 13/24

(57) ABSTRACT

A connector for making contact with at least one electrical element on a machine element, a machine element having at least one electrical element that has a plurality of contact pads, and a method for making contact with contact pads on a machine element with respectively associated contacts on a connector are provided. The contacts of the connector are connected to corresponding contact pads on the machine element. At least one contacting element is used to make a permanently electrically conductive connection between the contacts of the connector and the contact pads of the machine element.

The present invention relates to a connector for the contacting of at least one electrical element on a machine element. Specifically, the machine element is configured with a plurality of contact pads on the at least one electrical element, by which the at least one electrical element can be electrically contacted with the connector.

The invention also relates to a machine element with at least one electrical element, which is configured with a plurality of contact pads.

The invention also relates to a method for making contact with contact pads on a machine element. The contacting of contact pads on the machine element, using the contacts allocated for this purpose, is executed by a connector.

### BACKGROUND

Previously, the electrical contacting of electrical elements, including, e.g. adhesive-bonded flexible printed conductors, adhesive-bonded, caulked or riveted circuit boards or functional laminated systems etc., on a machine element has been executed by bonded connections. These bonded connections show limited mechanical robustness. On large machine elements, it is complex, if not virtually impossible, to form bonded connections, as large machine elements cannot be inserted in the bonding installations. The production of individually-applied bonded connections is complex and expensive. Moreover, bonded connections pose a problem, in that they cannot easily be released and re-bonded. This is particularly disadvantageous for service purposes.

### SUMMARY

The object of the invention is to provide a connector for the contacting of at least one electrical element on a machine element, by which it is possible to form a simple, secure and electrically-functional connection with the contact pads on the machine element.

This object is fulfilled by a connector for the contacting of at least one electrical element on a machine element with one or more features of the invention.

A further object of the invention is the configuration of a machine element with at least one electrical element provided with a plurality of contact pads, such that the electrical contacting of the contact pads on the machine element can be achieved in a simple, cost-effective and secure manner.

This object is fulfilled by a machine element with one or more features of the invention.

A further object of the present invention is to provide a method for the contacting of contact pads on a machine element with their respectively associated contacts of a connector which is simple to execute and which permits the secure and accurate contacting of the individual contact pads by the individual contacts of the connector.

This object is fulfilled by a method having one or more features of the invention.

The invention has the advantage in that, for the formation of electrical contact between the contacts of the connector and the contact pads on the machine element, only a one-off positioning of the connector is required. To this end, the connector and the machine element are configured such that only one option is available for the positioning of the connector in relation to the machine element. A secure electrical connection is thus formed between the contact pads on the machine element and the contacts of the connector. The user can therefore be certain in the knowledge that, by use of the connector which is bonded with the machine element, the correct contacting of the contact pads and the contacts is achieved. The invention has a further advantage, in that the release of the connection between the connector and the machine element, and the subsequent re-formation of contact, is possible. In the event of a repair, this is both desirable and necessary, as the costs incurred in the event of a repair can be substantially reduced accordingly.

The present invention likewise has an advantage, in that cost-intensive and high-precision process steps are not executed on the individual machine elements. As already mentioned above, the accurate contacting of the contact pads on the machine element with the contacts of the connector is achieved by the use of standardized connectors, thus permitting the exact contacting of the contact pads or contacts.

By use of the connector according to the invention, the contacting of at least one electrical element on a machine element is possible, whereby the machine element is provided with a plurality of contact pads on the at least one electrical element. The connector itself is provided with a plurality of contacts, each of which must be connected to one of the plurality of contact pads on the machine element. For the formation of electrical contact, at least one contacting element is provided. By use of the contacting element, it is thus possible to form a permanent and electrically-conductive connection between the contacts of the connector and the contact pads on the machine element.

The at least one electrical element can be configured, e.g., in the form of adhesive-bonded flexible printed conductors, adhesive-bonded, caulked or riveted circuit boards or functional laminated systems. However, the above list is not to be interpreted as a limitation of the invention. A person skilled in the art will be aware of the design of an electrical element which permits the use thereof on a machine element.

In order to permit the execution of an accurate and secure contacting of the contact pads on the machine element with the contacts of the connector, the connector is configured with at least one positioning element. A circuit board is provided in the connector, which carries the contacts. The circuit board may be, for example, a printed circuit board or a flex-board.

In the connector according to the invention, an electrically-conductive element is arranged between the contact pads on the machine element and the contacts of the connector. According to a first form of embodiment of the invention, the electrically-conductive element is an electrically-conductive self-adhesive strip or a conductive adhesive, which is arranged between the contact pads on the machine element and the contacts of the connector. According to a further form of embodiment of the invention, the electrically-conductive element arranged between the contact pads on the machine element and the contacts of the connector may be a self-adhesive strip which is electrically-conductive in the Z-axis only. This has an advantage, in that no electrically-conductive element needs to be applied to the individual contacts of the machine element or the individual contacts of the connector. According to a further form of embodiment of the invention, the electrically-conductive element, which forms the electrical contact between the contact pads on the machine element and the contacts of the connector, is a spring-loaded contact. According to one form of embodiment of the invention, the electrically-conductive element is a sphere, which is spring-loaded. To this end, a sphere is assigned to each individual contact of the connector or each individual contact pad of the machine element, which is independently spring-loaded.

For the generation of the contact pressure of the contacts of the connector in relation to the contact pads on the machine element, a single elastic element may be provided. A single elastic element, which can be configured as a spring element, is recommended for those forms of embodiment in which an electrically-conductive self-adhesive strip or an electrically-conductive adhesive is arranged between the contact pads on the machine element and the contacts of the connector.

In the form of embodiment of the connector in which the electrically-conductive element is a sphere, an elastic element is assigned to each of the spheres, which compresses the respective sphere against the contact pad of the machine element, thus forming an electrically-conductive connection with the relevant contact of the connector. Here again, the elastic element is a spring, so that the compressive force of the spheres against the individual contact pads on the machine element is constructively adjusted such that the contact pads on the at least one electrical element can be reliably contacted, with no associated damage to the electrical element.

One advantage of the contact elements which are pre-tensioned by a spring, such as e.g. spheres, is that an electrically-conductive connection can be reliably formed, regardless of external and internal influences. The spring contacts also have an advantage, in that they can offset any irregularities or deviations in the contours of a flat surface. Moreover, spring loading ensures that the electrical conductivity of contact points, over their service life, is only affected to a very limited extent, if at all, by environmental influences such as e.g. temperature or vibrations.

Moreover, a sealing element is provided, which is arranged between the connector and the machine element. The sealing element encloses an area of the contacts of the connector and an area of the contact pads on the machine element, such that a seal against environmental influences is formed accordingly. According to one form of embodiment, the sealing element may be an O-ring, which is secured correspondingly between the connector and the machine element. The circumferential seal can be molded onto the outgoing conductors from the connector (such as, e.g., the flex-board).

According to an alternative form of embodiment, the sealing element can be formed by a mechanical and leak-tight adhesive bond between the connector and the machine element. For the purposes of repair, it is advantageous that the mechanical and leak-tight adhesive bond is detachable.

The machine element according to the invention has at least one electrical element, which is configured with a plurality of contact pads. For the electrical contacting of the contact pads on the machine element with the contacts of a connector, the contact pads on the machine element are arranged in a mounting area for the connector. The mounting area is configured such that the latter cooperates with a positioning element on the connector. Cooperation between the mounting area of the machine element and the positioning element of the connector is understood to operate by the lock-and-key principle. The specific configuration of the mounting area on the machine element and the positioning element of the connector has an advantage, in that it permits a simple and permanently electrically-conductive connection between the contacts of the connector and the associated contact pads on the machine element.

A sealing element is provided between the connector and the machine element, which encloses the contact area of the connector and the contact pad area of the machine element, thereby protecting the entire unit against environmental influences, such that no damage can be sustained by the electrically-conductive connection between the contact pads on the machine element and the contacts of the connector.

According to a further form of an embodiment of the invention, a method is provided for the contacting of the contact pads on a machine element with respectively associated contacts of a connector. Firstly, for the accurate positioning of the connector, a mounting area is provided on the machine element. The connector and the mounting area on the machine element cooperate such that each contact of the connector forms an electrically-conducting connection with a correspondingly associated contact pad on the machine element. Finally, a circumferential seal is formed around the mounting area, which carries the plurality of contact pads, when the connector is connected to the machine element.

In order to facilitate the positioning of the connector in relation to the machine element and to achieve the secure and respectively accurate contacting of the contact pads on the machine element with the respectively associated contacts of the connector, at least one positioning element is provided on the connector. This has an advantage, in that complex adjustment or positioning operations for the achievement of secure and accurate contacting can be omitted.

The connector itself is provided with a retaining device, which can be of robust design and which has the contacts of the connector for the contact pads of the at least one electrical element on the machine element. The retaining device, for example by use of one or more screws, can be secured to the machine element such that a specific contact pressure setting is delivered by the tightening torque of the screws. Accordingly, a compressive force is applied to the self-adhesive strip, or to the conductive adhesive, or to the individual spheres which create the electrically-conductive contact between the contact pads on the machine element and the contacts of the connector. The robustness and temperature resistance of the electrical contacting between the contact pads on the machine element and the contacts of the connector are delivered accordingly. Alternatively, contact pressure can be achieved by the configuration of the clearances between the mounting and contact surfaces to deliver mechanical engagement or pre-tensioning. As already indicated, the setting of a specific contact pressure can also be achieved, e.g., by a spring element. The spring element may be provided as an individual spring element or, according to one form of embodiment of the invention, the spring element can be associated respectively with an individual sphere, by which contacting is achieved between the contact pads on the machine element and the contacts of the connector. As an alternative to the attachment of the retaining device of the connector to the machine element by the use of screws, the adhesive bonding of the retaining device to the machine element can also be envisaged. Further connection techniques, such as, e.g., riveting, expansion plugs, press-fitting into a corresponding recess or bore or the mounting area of the machine element can also be envisaged. Preferably, however, the connection techniques selected are those which permit subsequent detachment for the purposes of repair.

According to the invention, the connector can be effectively sealed by a simple arrangement. The connector can be mass-produced as a standardized component, and can therefore be manufactured cost-effectively, for fitting to differing individual machine elements with electrical elements. By the one-off positioning of a standardized connector, cost-intensive bonding to individually differing machine elements can be reduced accordingly. It is also advantageous that, for the purposes of repair, the connector can be removed and re-positioned thereafter.

### BRIEF DESCRIPTION OF THE DRAWINGS

Exemplary embodiments of the invention and the advantages thereof are described in greater detail hereinafter, with reference to the attached figures. Dimensional proportions in the figures do not always correspond to the actual dimensional proportions, as some shapes have been simplified, while other shapes are shown in an enlarged representation, in relation to other elements, in the interests of greater clarity. Herein:

FIG. 1 shows a schematic sectional view of the connection of the connector and the machine element, according to one form of embodiment of the invention;

FIG. 2 shows a schematic representation of the connection between the connector and the machine element, according to a further form of embodiment of the invention;

FIG. 3 shows a schematic representation of one form of embodiment of the invention, in which the connector is adhesively bonded to the machine element;

FIG. 4 shows a schematic representation of a further form of embodiment of the invention, in which a single conductive self-adhesive strip is arranged between the contacts of the connector and the contact pads on the machine element;

FIG. 5 shows a further schematic view of one form of embodiment of the invention, in which a single elastic element is provided, by which the contacts of the connector are mechanically pre-tensioned against the contact pads on the machine element;

FIG. 6 shows a schematic view of a further form of embodiment of the invention, in which a single electrically-conductive element is provided for each contact pad on the machine element, which is mechanically pre-tensioned against the contact pads on the machine element;

FIG. 7 shows a further form of embodiment of the form of embodiment represented in FIG. 6, in which a spacing element is provided, by which the compressive force can be adjusted accordingly;

FIG. 8 shows a schematic view of a further form of embodiment, according to the representation shown in FIG. 7, in which the retaining device of the connector is adhesively bonded to the machine element;

FIG. 9A shows a schematic overhead view of the mounting area for the connector on the machine element; and

FIG. 9B shows a schematic overhead view of a connector, for the representation of a positioning element of the connector which cooperates with the mounting area represented in FIG. 9A.

### DETAILED DESCRIPTION OF THE PREFERRED EMBODIMENTS

Equivalent elements of the invention, or elements of equivalent function, are identified by the same reference numbers. Moreover, in the interests of clarity, the individual figures only include those reference numbers which are required for the description of the figure concerned. The forms of embodiment represented only constitute examples of the execution of the inventive connection between the machine element and the connector. The exemplary embodiments represented are not to be understood as limitations of the invention.

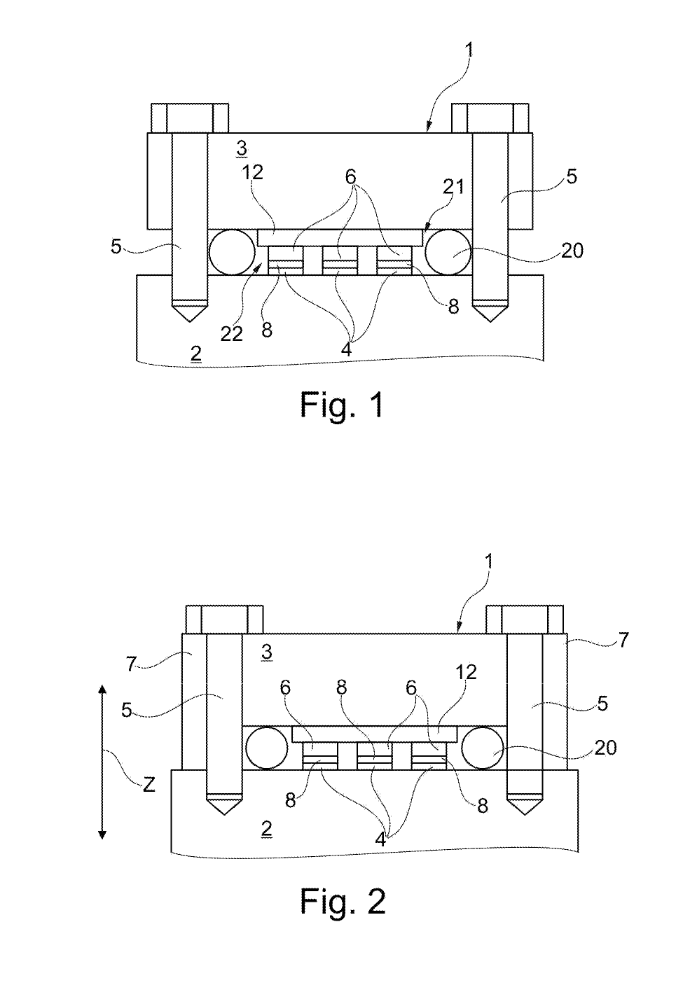

FIG. 1 shows one form of an embodiment of the present invention, in which a connector 1 is connected to a machine element 2. The connector 1 is provided with a retaining device 3 which, via at least one screw 5, is connected to the machine element 2. The connector 1 comprises a circuit board 12, which carries the contacts 6 of the connector 1. The contacts 6 of the connector 1 must form an electrically-conductive connection with the contact pads 4 on the machine element 2. To this end, in the present form of embodiment, an electrically-conductive self-adhesive strip or a conductive adhesive is arranged respectively as a contacting element 8 between the contacts 6 of the connector 1 and the contact pads 4 on the machine element 2. In the form of embodiment represented here, a sealing element 20 is arranged between the retaining device 3 of the connector 1 and the machine element 2. The sealing element 20 encloses the area 21 of the contacts of the connector and the area 22 of the contact pads on the machine element 2. In the embodiment represented here, the sealing element 20 is an O-ring. By use of the screws 5, the contact pressure of the contacts 6 of the connector 1 against the contact pads 4 on the machine element 2, and against the sealing element 20, can be adjusted. To this end, the screws 5 are tightened by a corresponding torque wrench, in order to achieve the secure and effective sealing of the area 21 of the contacts 6 of the connector 1 and the area 22 of the contact pads 4 on the machine element 2.

In the form of embodiment of the connection of the connector 1 and the machine element 2 shown in FIG. 2, the retaining device 3 comprises at least one spacing element 7. By use of the spacing element 7, the tightening force of the screws 5 is limited, such that a specific compressive force is applied to the sealing element 20 or to the contacts 6 of the connector 1 and the contact pads 4 on the machine element 2 in the Z-axis Z.

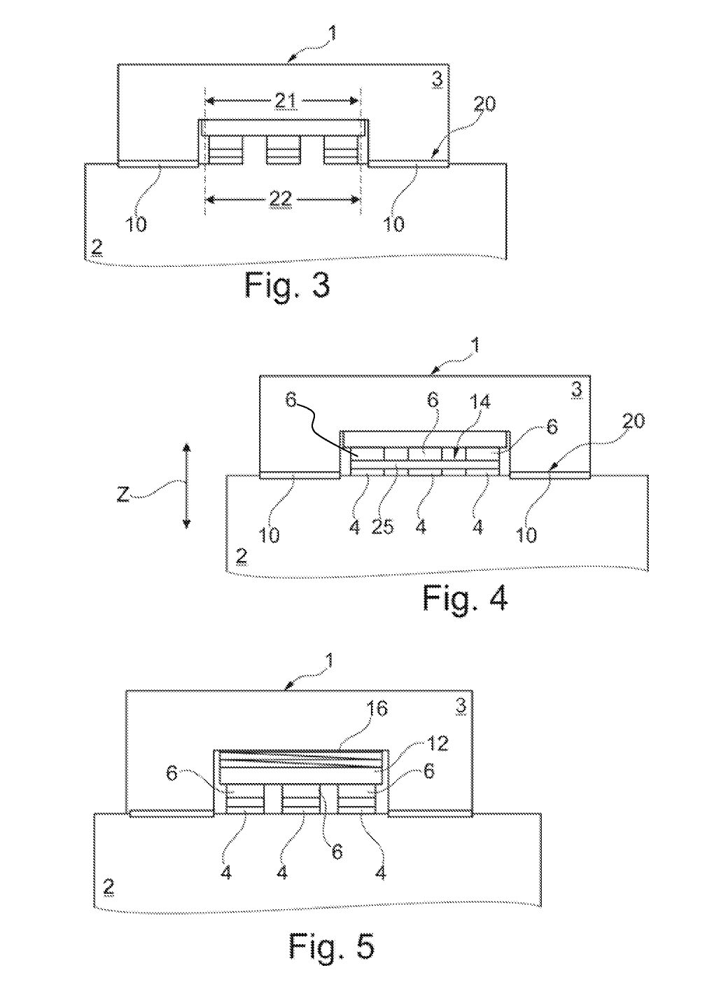

FIG. 3 shows a further form of embodiment of the connection of the connector 1 and the machine element 2. The retaining device 3 of the connector 1 is bonded to the machine element 2 by an adhesive joint 10. The adhesive joint 10 thus forms the sealing element 20 which encloses the area 21 of the contacts 6 of the connector 1 and the area 22 of the contact pads 4 on the machine element 2, thereby providing a seal against external environmental influences. The adhesive joint 10 forms a mechanical and leak-tight adhesive bond.

FIG. 4 shows a further form of embodiment of the present invention, wherein the form of embodiment represented here differs from that represented in FIG. 3 in that, between the contacts 6 of the connector 1 and the contact pads 4 on the machine element 2, the electrically-conductive element 14 is configured as a conductive self-adhesive strip 25 arranged in the Z-axis Z. This has an advantage, in that the conductive self-adhesive strip 25 arranged in the Z-axis Z can be applied to all the contact pads 4 on the machine element 2 or all the contacts 6 of the connector 1.

FIG. 5 shows a further form of embodiment of the present invention, which differs from the form of embodiment represented in FIG. 3 in that a single elastic element 16 is arranged between the connector 1 or the retaining device 3 and the circuit board 12. The single elastic element 16 can be configured as a spring element. The single elastic element 16 generates a predefined contact pressure of the contacts 6 of the connector 1 against the contact pads 4 on the machine element 2. By the contact pressure of the single elastic element 16, by the electrically-conductive element 14, the compressive force of the contacts 6 of the connector 1 against the contacts 4 of the machine element 2 is transmitted.

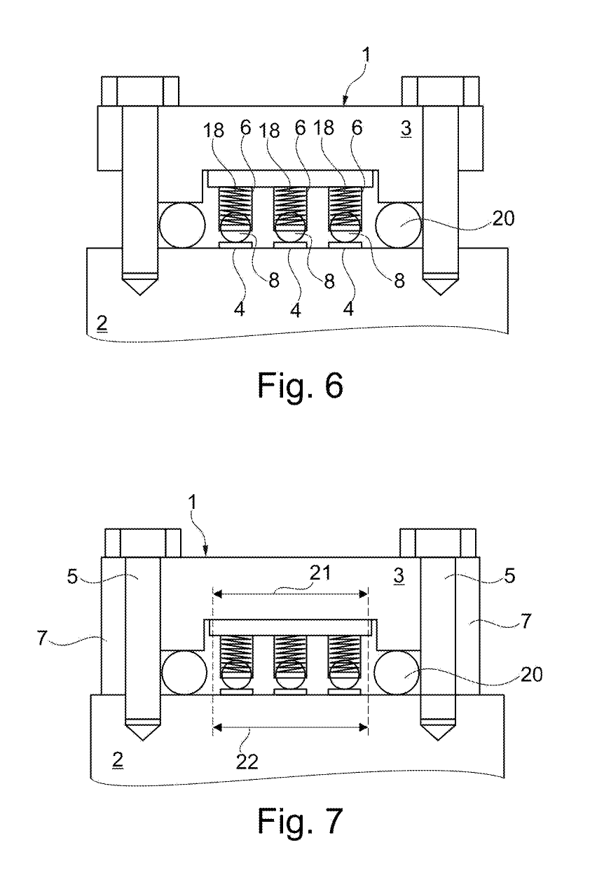

FIG. 6 shows a form of embodiment of the present invention, which is similar to the form of embodiment represented in FIG. 1. The only difference between the form of embodiment represented in FIG. 6 and that represented in FIG. 1 is that the contacting elements 8, which form the electrically-conductive contact between the contact pads 4 on the machine element 2 and the contacts 6 of the connector 1, are configured in the form of spheres. In this arrangement, each of the spheres is pre-tensioned by an elastic element 18. The elastic element 18 can be, for example, a spring which compresses the spheres of each contact 6 of the connector 1 against a corresponding contact pad 4 on the machine element 2. It will be obvious to a person skilled in the art that the contacting element is not limited to a spherical form alone.

In the form of embodiment represented in FIG. 7, the retaining device 3 of the connector 1 is provided with at least one spacing element 7. By use of the spacing element 7, the tightening force applied by the screws 5 is limited. As represented in FIG. 1 and FIG. 2, and in FIG. 6 and FIG. 7, a sealing element 20 is provided, which is configured as an O-ring. The sealing element 20 encloses the area 21 of the contacts 6 of the connector 1 and the area 22 of the contact pads 4 on the machine element 2. Accordingly, the electrical contacts are sealed in relation to the external environment or surroundings.

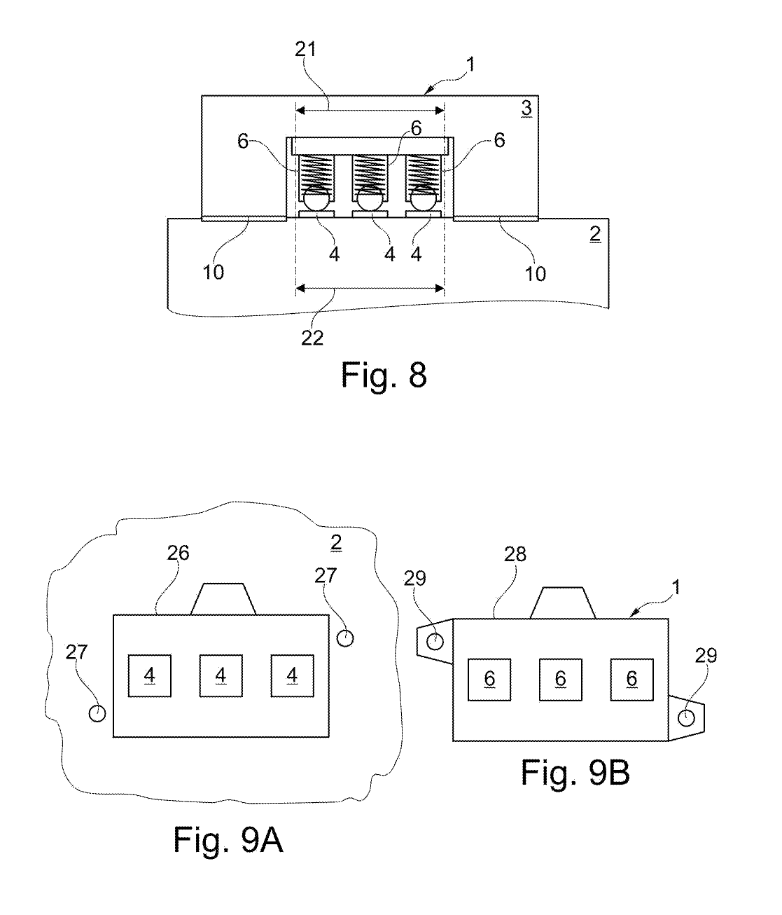

In the exemplary embodiment represented in FIG. 8, the contacting of the contacts 6 of the connector 1 and the contact pads 4 on the machine element 2 is effected in a comparable manner to that described above with reference to FIG. 6 and FIG. 7. This form of embodiment differs in that the retaining device 3 of the connector 1 is bonded to the machine element 2 by an adhesive joint 10. As described above with reference to the other forms of embodiment, the adhesive joint 10 forms a mechanical and leak-tight adhesive bond, which also encloses the area 21 of the contacts of the connector 1 and the area 22 of the contact pads 4 on the machine element 2, thereby providing a seal against the surroundings.

FIG. 9A shows an overhead view of a mounting area 26 for a connector 1, which is configured on the machine element 2. The mounting area 26 encompasses the contact pads 4 of the mounting element 2. The mounting area 26 can also be associated with at least one threaded pin or threaded bore 27, which additionally ensures the correct fitting of the connector 1 to the machine element 2. FIG. 9B represents a positioning element 28 of the connector 1, which is configured with a complementary profile to the mounting area 26. By use of the at least one positioning element 28, the accurate fitting or the correct connection of the connector 1 to the machine element 2 can thus be executed. Two or more positioning elements can, e.g., be arranged asymmetrically on the connector 1, such that any inadvertent incorrect positioning of the connector 1 in relation to the mounting area 26 of the machine element 2 is prevented. At the same time, with no additional complexity in arrangements for fitting and adjustment, it can be ensured that an electrically-conductive connection between the contact pads 4 on the machine element 2 and the contacts 6 of the connector 1 is in place, if the connector 1 is arranged in the functional position in relation to the machine element 2. Additionally, a bore 29 may be formed in the positioning element 28, which can accommodate a threaded pin or a screw 5, such that the connector 1 is additionally tensioned against the machine element 2 via the retaining device 3.

### LIST OF REFERENCE NUMBERS

1 Connector
2 Machine element
3 Retaining device
4 Contact pad
5 Screw
6 Contact
7 Spacing element
8 Contacting element
10 Adhesive bond
12 Circuit board
14 Electrically-conductive element
16 Single elastic element
18 Elastic element
20 Sealing element
21 Area of contacts
22 Area of contact pads
25 Conductive self-adhesive strip in Z-axis
26 Mounting area
27 Threaded pin, threaded bore
28 Positioning element
29 Bore
Z Z-axis

1. A connector for the contacting of at least one electrical element on a machine element, the machine element is provided with a plurality of contact pads for the electrical element, the connector comprising a plurality of contacts, each said contact is connectable to one of the plurality of contact pads on the machine element, and at least one contacting element adapted to form a permanent and electrically-conductive connection between the contacts of the connector and the contact pads on the machine element.

2. The connector as claimed in claim 1, further comprising at least one positioning element, for forming an electrically-conductive connection between the contact pads on the machine element and the contacts of the connector.

3. The connector as claimed in claim 1, further comprising a circuit board that carries the contacts.

4. The connector as claimed in claim 3, wherein an electrically-conductive element is arranged as the contacting element between the contact pads on the machine element and the contacts of the connector.

5. The connector as claimed in claim 4, further comprising a single elastic element that acts on the circuit board of the connector, such that the contacts of the connector are adapted to be compressible against the contact pads on the machine element.

6. The connector as claimed in claim 3, wherein each said contact of the connector is provided with an elastic element, such that each said contact of the connector is adapted to be compressible against an associated contact pad on the machine element.

7. The connector as claimed in claim 1, further comprising a sealing element provided between the connector and the machine element, said sealing element encloses an area of the contacts on the connector and an area of the contact pads of the machine element.

8. A machine element comprising at least one electrical element provided with a plurality of contact pads, the plurality of contact pads are arranged in a mounting area for a connector and the mounting area is configured such that the mounting area cooperates with at least one positioning element on the connector, thereby forming a permanently electrically-conductive connection between the contacts of the connector and the associated contact pads on the machine element.

9. The machine element as claimed in claim 8, wherein a sealing element is provided between the connector and the machine element, which encloses an area of the contacts of the connector and an area of the contact pads on the machine element.

10. A method for the contacting of contact pads on a machine element with respectively associated contacts of a connector, comprising:
providing at least one positioning element on the connector;
providing a mounting area for the connector on the machine element, arranging the connector on the mounting area on the machine element such that each of the contacts of the connector forms an electrically-conducting connection with a correspondingly associated one of the contact pads on the machine element; and
forming a circumferential seal around the mounting area, which carries the plurality of contact pads, when the connector is connected to the machine element.
